(19) United States
(12) Patent Application Publication
(10) Pub. No.: US 2009/0070866 A1
(43) Pub. Date: Mar. 12, 2009

(54) METHODS AND SYSTEMS FOR SECURE EMAIL TRANSMISSIONS

(76) Inventor: Glade Erikson, Glendale, AZ (US)

Correspondence Address: WILSON SONSINI GOODRICH & ROSATI, 650 PAGE MILL ROAD, PALO ALTO, CA, 94304-1050, US

(21) Appl. No.: 11/853,772

(22) Filed: Sep. 11, 2007

(51) Int. Cl. H04L 9/28

(52) U.S. Cl. 726/14

(57) ABSTRACT

Systems and methods for email monitoring and providing sender notification of security levels for outbound email recipients prior to transmission or sending of emails.

### BACKGROUND OF THE INVENTION

Data security is increasingly important for a variety of entities that use email for communication. As a result, some entities are creating secure email channels using the SSL (Secure Socket Layer) protocol, the TLS (Transport Layer Security) protocol, various email encryption methods, or other means of email security for communication with email partners. It may be that for any one entity, some email partners have a secure email channel created while other partners are unsecured. As an example, an email user inside a company's email firewall may have a secure email channel with other users within that firewall, and not have a secure email channel for users outside of the firewall. In another example, an email user may have secure email channels within the company's firewall, and with selected entities outside the firewall that have had a secure email channel created (via SSL/TLS, etc), but may not have a secure email channel with all entities outside of the firewall . To help protect and secure data, it would be valuable for email senders to know which potential recipients have a secure email channel.

### SUMMARY OF THE INVENTION

The invention provides methods and apparatus for providing email security by monitoring predefined levels of security for intended recipients before transmissions are delivered by senders. Various aspects of the invention described herein may be applied to any of the particular applications set forth below. The invention may be applied as a standalone tool or as part of an integrated software solution against breaches of email security policies or unauthorized dissemination of information through email transmissions. It shall be understood that different aspects of the invention can be appreciated individually, collectively or in combination with each other.

An aspect of the invention provides methods of monitoring outbound email traffic for unauthorized transmissions. A preferable embodiment of the invention notifies email senders of a certain level of security that may be assigned to one or more email recipients. Before transmitting an email message, which may or may not include attachments, the level of security for addressed recipients is checked. Another aspect of the invention provides systems for detecting and blocking email transmissions to selected recipients or those with an inadequate level of security. Another preferable embodiment of the invention includes an email security system that may also block emails when one or more channels to potential recipients are not secure.

In yet another embodiment of the invention, violations of email security policies can be detected and thwarted by implementing the methodologies and systems herein. Confidential information or other limited access information can be protected by preventing the transmissions of emails before they leave a secured enterprise network environment. The unauthorized distribution of emails to unapproved or selected recipients can therefore be halted or limited.

Another aspect of the invention provides systems and apparatus for the monitoring and/or detecting of security levels corresponding to intended email recipients. A database may collect email address information including the domain names of email recipients, wherein some or all recipients may have a corresponding level of security assigned to them.

Other goals and advantages of the invention will be further appreciated and understood when considered together with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized.

FIG. 1 illustrates methods of monitoring and notifying email senders of applicable levels of security for intended recipients.

FIG. 2 illustrates methods of determining security levels of email channels for intended email recipients and notification of the same to senders.

FIG. 3 describes an email security system that monitors emails to intended recipients both external email recipients and those within the firewall of a secured network environment.

FIG. 4 illustrates the various modules that may be included in email security systems provided herein which have access to databases containing email address information.

FIG. 5 is a table with email address information and corresponding levels of security that may be stored in a database coupled to an email security system.

### DETAILED DESCRIPTION OF THE INVENTION

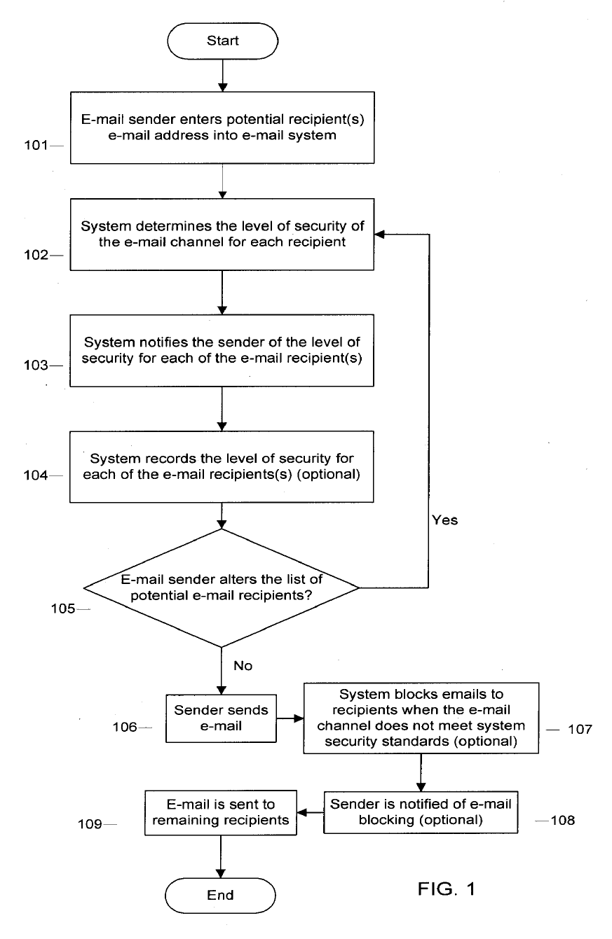

FIG. 1 is a flowchart illustrating a method provided in accordance with an aspect of the invention to notify the sender of the respective levels of security for potential email recipients across an email channel. An embodiment of the invention may block emails to recipients whose email channel does not meet the minimum security level designated by the system. For purposes of describing the invention herein, the term “email” includes all forms of electronic mail or e-mail.

In step 101 of FIG. 1, the email sender may enter the email address(es) for the intended receiver(s) of an email. There may be more than one intended recipient. In step 102, the system determines the security level of the email channel(s) for each of the intended recipients. In step 103, the system notifies the sender of the security level of each potential recipient. Notification may be done in a variety of ways, including a security indication next to the email address of the recipient, highlighting the recipients email address in different colors, notification in the body of the email or in other ways.

As an optional step 104, the system may record the level of security for each recipient. Recording of the security level again may be accomplished in many ways, including recording the security level in the email heading or in the email itself

Once the system notifies the sender of the security of the email channel, the sender may alter the list of receipts by adding, altering or removing from the list of intended recipient as shown in step 105. If any alterations occur, the system can re-assesses the security level of the email channel for each recipient.

If there are no alterations to the list of recipients, the sender may initiate sending the email in step 106. As an optional step, the system may block outgoing email if the security of an email channel for an intended recipient does not meet the preset standards housed in the email system, as shown in step 107. Step 108 illustrates that the sender may be notified if some outgoing email was blocked in step 107. In step 109, the email is then sent to the recipients that have not been blocked in step 107.

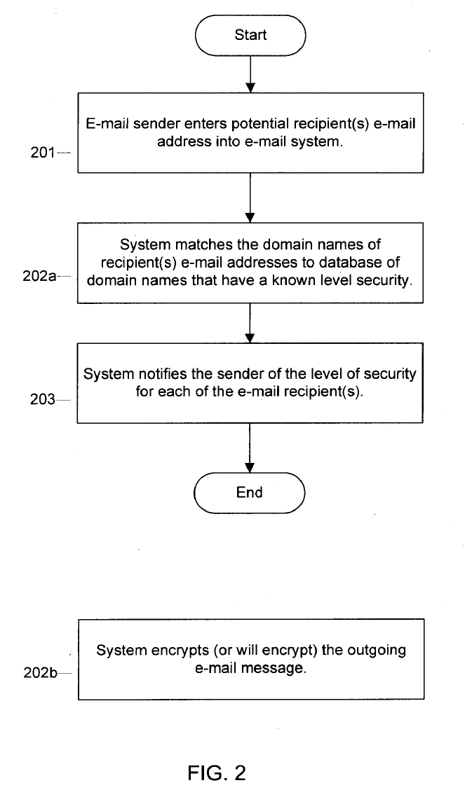

FIG. 2 is a flowchart illustrating two example methods of determining the security level of the email channel to an intended recipient.

In FIG. 2, in step 201 the email sender enters the email address of the potential email recipient as in step 101.

An example method of determining the security level of an email channel is illustrated in step 202a. In step 202a the system has stored email domain names that have a known security level. In examples, public domain names may be designated as relatively unsecure. Meanwhile, domain names behind a company's firewall may be designated as relatively secure. Domain names that had or are known to have a secure email channel created (via SSL/TLS, etc), may also be designated as relatively secure. In other examples, domain names which may be unknown to the system may include security levels designated as unknown. The domain names of intended email recipients may then be matched by systems herein relative to a database to determine the security level for each intended email recipient.

In another example, step 202b may replace step 202a. In step 202b, the system may encrypts (or will encrypt) an outgoing email message. Since the outgoing email is encrypted, the system may determine that the email is secure even when previously it was deemed not secure prior to encryption.

In examples, other methods may be used to determine the security level of the email recipients, and replace steps 202a and/or 202b.

In step 203 the system would notify the email sender of the security level of each intended email recipient, as in step 103.

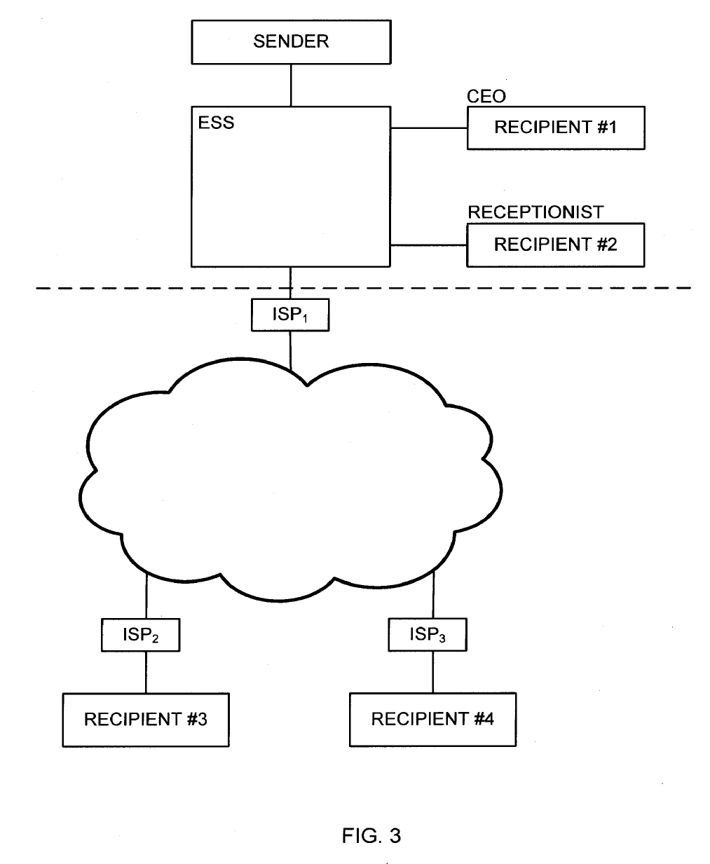

As shown in FIG. 3, an email security system may be implemented as part of or within a firewall or enterprise network. The sender of an email within a network may deliver messages to recipients within the network and outside of the network. An email exchange server may be coupled to or integrated with the email security system (ESS) which receives the intended email for analysis before its distribution. The ESS can monitor email traffic or outbound emails to internal and/or external email recipients. Depending on the level of security for the intended recipient(s) and/or their corresponding email channels, the email may be successfully delivered to intended recipients. An embodiment of the invention controls the delivery of email to certain individuals depending on their respective email addresses. For example, Recipient #1 of an email may possess an adequate security level to receive an email (CEO of a company) while Recipient #2 may not (Receptionist). This may limit the ability to accidentally or intentionally share sensitive or mission critical information with others within a network. Alternatively, all names and delivery channels behind a company's firewall may be designated as relatively secure so that all emails within a company can be freely delivered without delay.

Meanwhile, outside email transmissions with public domain names over the Internet can be provided through a selected Internet Service Provider (ISP1). These transmissions may be designated as generally unsecure. However when domain names with which secure email channels have been created (via SSL/TLS, etc) or established, they may be designated as relatively secure. For example, when the sender of an email wants to deliver messages to recipients (Recipient #3 and #4) outside of the network over the Internet, their respective channels of communication may be deemed ahead of time as either secure or unsecure. These recipients may access the Internet through their respective Internet Service Providers (ISP2 and ISP3). When the ESS confirms a secure email channel exists are is already in place, or the intended email recipients are otherwise permitted to receive emails from the sender, the delivery of the email can be completed from the sender to recipients outside of a network such as a local area network to a wide area network such as the Internet.

The Internet may be described generally as a collection of computers, networks, routers, and gateways that use the TCP/IP suite of protocols to connect computers all over the world. The Internet links computers together in a way such that they can transfer information to each other. Computer users often subscribe to communication services provided by ISPs to access and utilize the Internet.

One of the most popular uses of the Internet is to send and receive electronic messages (aka electronic mail, e-mail, email). Email may be described as a computer-to-computer version of interoffice mail or the postal service. It enables computer users to send and receive messages over a computer network. Delivered messages can be stored in electronic mailboxes that are assigned to users on the network. Messages received in a mailbox can be viewed, saved, or deleted by a recipient using known and popular electronic mail computer software such as CE Software's QUICKMAIL™, OUTLOOK™ made by Microsoft Corporation, EUDORA™ made by Qualcomm, and the like.

An addressing scheme is commonly used to properly deliver email. Each computer on the Internet is assigned a numeric Internet protocol (“IP”) address, which is a part of the TCP/IP protocol. The IP address in the current TCP/IP scheme consists of four discrete numbers, each less than 256, separated by dots (e.g., 123.4.5.678). A distinct IP address is assigned to each different computer that is connected to the Internet. The domain names for computers are often used on the Internet rather than the IP numbers themselves.

Typical email messages are addressed to a recipient in the form of “username@domain name_domain,” where username is a form of name for a message recipient, domain_name is a lower level domain name assigned to an organization or an ISP, and domain is a top level domain name. Present top level domain names are limited and can be the U.S. government (.gov), the U.S. military (.mil), a network (.net), a commercial enterprise (.com), an educational institution (.edu), or a country (e.g., .jp for Japan or .uk for the United Kingdom). For example, Jane Doe may subscribe to Internet service provided by a commercial enterprise or ISP called “NewCo, Inc.” and be given an email address in the form of jane_doe@newcoinc.com.

Domain name servers (“DNSs”) translate between the domain_name.domain portion of an email address and the numeric Internet protocol (“IP”) address. When a message with an email address is received at an ISP from one of its subscribers, the ISP employs a DNS to look up the numeric IP address associated with the email address. Using the IP address of the message, the ISP transmits the message-to electronic devices such as routers, which selects one of possibly several different data communication paths connected to another computer and sends the message to the other computer. The message can be passed from computer to computer, via their respective connected routers, until the message arrives at a computer associated with the ultimate intended recipient. Typically, the final computer to receive the message is a computer operated by the ISP to which the recipient subscribes. The message is then stored in a mailbox associated with the subscriber, and the subscriber is often notified via email software that he or she has mail in the mailbox.

A particular problem addressed by the invention is the unauthorized delivery of emails to intended recipients. After an email address is identified as not having an adequate security level to receive such an email, the intended email can “bounce” back to the sender in accordance with an embodiment of the invention. In other words, the message is not delivered to the intended recipient(s) and the sender may be notified of such and/or a network administrator may be notified of the attempted delivery so that any appropriate network security action may be taken. A predefined bounce message may be sent to the sender often including a text string containing the text “message undeliverable” with an explanation for the failure. The message may be used to inform the sender that there was a problem with the attempted delivery of the message.

According to another embodiment of the invention, after a sender receives a bounce message, the sender may modify or seek to modify the level of security for the rejected recipient. The user or someone with adequate network security clearance can modify the corresponding security level for the rejected recipient so that a subsequent attempt will permit the delivery of message. Additionally, a secure channel can be established with the recipient following initial rejection so another transmission can be completed after appropriate security measures are implemented.

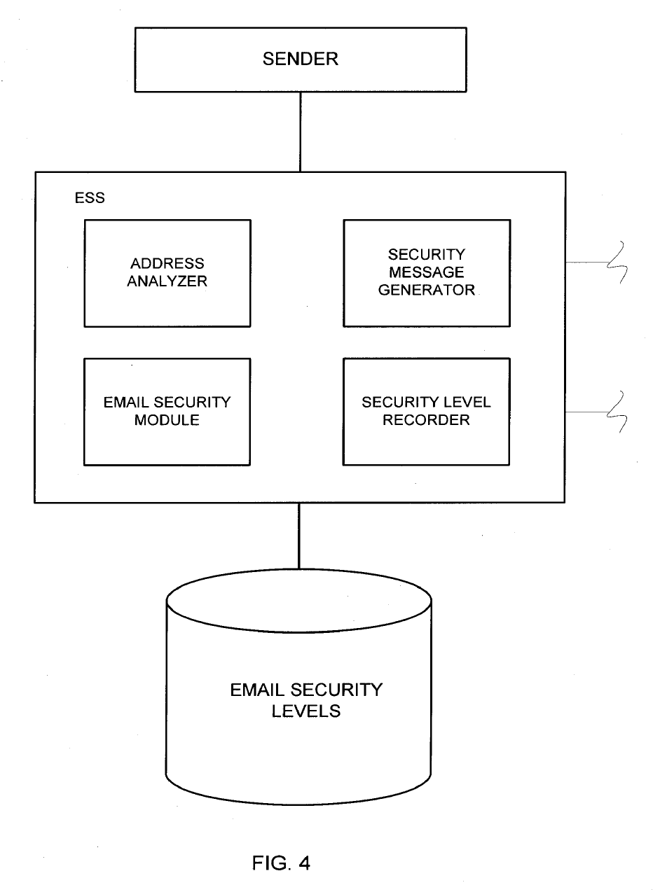

FIG. 4 illustrates the various modules that may be included in email security systems provided herein which have access to databases containing email address information. An ESS may include an address analyzer to identify the email address or related domain names for email recipients. The ESS may determine the security level of the email channel(s) for each of the intended recipients. The email security level information may be stored in a series of one or more databases coupled to the ESS. In addition, the ESS may include a security message generator for creating notifications to senders of the security level of potential recipients. Notification may be done in a variety of ways, including a security indication next to the email address of the recipient, highlighting the recipients email address in different colors, notification in the body of the email or in other ways. Moreover, the ESS include a security level recorder to record the level of security for each recipient. Recording of the security level again may be accomplished in many ways, including recording the security level in the email heading or in the email itself. An email security module may be also included in the ESS to handle attempts to deliver emails to recipients with inadequate security levels. For example, when an email channel to a recipient is deemed to be unsecure, an encryption program may be execute to encrypt the email and its contents prior to delivery automatically or manually. By encrypting the message, it can be re-categorized as secure and thus reach the intended recipient(s). The aforementioned modules may computers software programs or computer implemented instructions to carry out the methods of the invention. It shall be understood that any or all of the aforementioned modules and others may be included in the ESS embodiments herein.

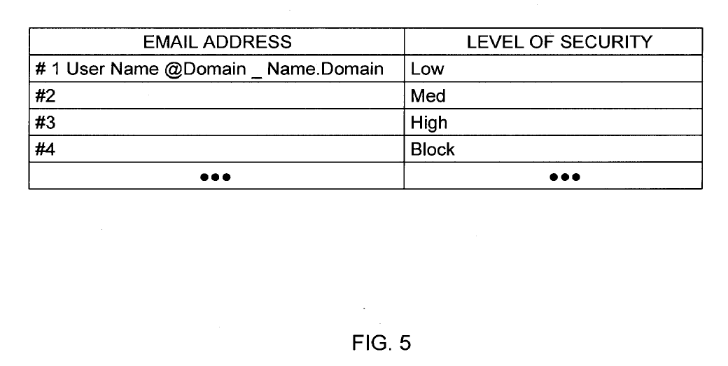

FIG. 5 is a table with email address information and corresponding levels of security that may be stored in a database coupled to an email security system. Any email address may be stored along with an associated domain name. A predetermined level of security may be selected (Low Med High) that determines the threshhold needed before an email is permitted to be sent to one or more recipients. If an wholly inadequate email channel is available, or if an intended email recipient or certain domain name is not to receive any emails, the invention here can block or bounce back such email attempts.

Furthermore, the email address databases herein may also track or match current email addresses with alternative or old/prior email addresses. Old email and new email address information can be correlated as described in U.S. Pat. No. 6,654,779 (Tsuei) which is incorporated by reference herein in its entirety. Accordingly, unauthorized or impermissible email transmissions can be stopped or limited in accordance with this embodiment even when the email addresses of such potential recipients are changed or if alternative email addresses are used.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for email security notification comprising:
entering one or more email addresses for at least one intended recipient of an email;
determining a security level for an email channel corresponding to each intended recipient; and
notifying a sender of the security level for each intended recipient prior to delivery of the email.

2. The method of claim 1, wherein the step of notifying the sender includes providing a security indication next to the email address of the intended recipient.

3. The method of claim 1, wherein the step of notifying the sender includes highlighting the intended recipient email address in different-colors within a user interface.

4. The method of claim 1, further comprising the step of:
providing the sender a list of each intended recipient with a corresponding security level; and
altering the list of each intended recipient after notifying the sender of the security level for each intended recipient by adding, altering or removing from the list of intended recipient.

5. The method of claim 1, further comprising the step of:
initiating delivery of the email to the at least one intended recipients; and
blocking the email when the security of an email channel for an intended recipient does not meet a predetermined security standard.

6. The method of claim 5, wherein the sender is notified when the email is blocked.

7. The method of claim 5, wherein the email is encrypted prior delivery of the email.

8. An email security system comprising:
an exchange server for receiving emails for analysis before their delivery within or outside a local computer network;
an email information database containing security level information for a plurality of email recipients or addresses across at least one email communication channel; and
an analyzer for determining whether the emails satisfy preselected security levels based on the email communication channel for each corresponding email recipient or address.

9. The email security system of claim 8, further comprising:
a security message generator for delivering a predefined bounce back message to inform a sender whether the emails do not satisfy preselected security levels.

10. An email security system comprising:
an address analyzer to identify the email address or related domain names for one or more email recipients; and
an email security module containing an encryption program for encrypting an email when the security level for a communication channel corresponding to an email recipient falls below a predetermined security threshold.

11. The system of claim 10, further comprising:
a security message generator for creating a notification to a sender of the email that the predetermined security threshold for the email recipient has not been met.

12. The system of claim 11, wherein the security level recorder information is included within a heading or body of the email.

13. The system of claim 10, further comprising:
a security level recorder to record the security level for each email recipient.

14. The system of claim 10, further comprising:
an email security module for processing attempts to deliver the email when the predetermined security threshold has not been met.

15. The system of claim 14, wherein the email security module contains and executes an encryption program to encrypt the email prior to delivery when an email channel to a recipient is deemed to be unsecured.

16. The system of claim 10, further comprising:
a database for storing a plurality of email addresses or domain names for one or more email recipients, wherein the email addresses or domain names have a corresponding predetermined security threshold.
